(19) United States
(12) Patent Application Publication
(10) Pub. No.: US 2023/0363534 A1
(43) Pub. Date: Nov. 16, 2023

(54) ADJUSTABLE WELDER TABLE ASSEMBLY

(71) Applicants: Sierra Rebolledo, Laporte, TX (US); Samantha Rivera, Laporte, TX (US)

(72) Inventors: Sierra Rebolledo, Laporte, TX (US); Samantha Rivera, Laporte, TX (US)

(21) Appl. No.: 17/744,032

(22) Filed: May 13, 2022

(51) Int. Cl. A47C 1/024; B25H 5/00

(52) U.S. Cl. CPC A47C 1/024; B25H 5/00

(57) ABSTRACT

An adjustable welder table assembly includes a frame having a perimeter edge and includes a front member, a rear member, a first lateral member and a second lateral member. The frame has an interior surface and an exterior surface. The interior surface bounds an interior space. A plurality of legs is attached to the frame. The legs are pivotally coupled to the frame such that the legs are positionable in an extended position extending downwardly from the frame or in a stored position positioned within the interior and bounded by the frame. The frame is abuttable against a floor surface to define a lowest support position of the assembly when the legs are in the stored position. A platform is positioned on an upper surface of the frame for supporting a welder while performing a welding task.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to welder seat device and more particularly pertains to a new welder seat device for supporting a welder at a selected height to allow the welder to be seated comfortably during a welding project regardless of the height of the object being worked upon.

### (2) Description of Related Art Including Information Disclosed Under 37 CFR 1.97 and 1.98

The prior art relates to welder seat devices which provide seating for the welder but do not do so in a manner that allows for vertical adjustments as well as selectable back support.

### BRIEF SUMMARY OF THE INVENTION

An embodiment of the disclosure meets the needs presented above by generally comprising a frame having a perimeter edge and including a front member, a rear member, a first lateral member and a second lateral member. The frame has an interior surface and an exterior surface. The interior surface bounds an interior space. A plurality of legs is attached to the frame, the legs are pivotally coupled to the frame such that the legs are positionable in an extended position extending downwardly from the frame or in a stored position positioned within the interior and bounded by the frame. The frame is abuttable against a floor surface to define a lowest support position of the assembly when the legs are in the stored position. A platform is positioned on an upper surface of the frame for supporting a welder while performing a welding task.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a adjustable welder table assembly according to an embodiment of the disclosure.

FIG. 2 is a side view of an embodiment of the disclosure.

FIG. 3 is a bottom view of an embodiment of the disclosure.

FIG. 4 is a rear view of an embodiment of the disclosure.

FIG. 5 is a front view of an embodiment of the disclosure.

FIG. 6 is a side in-use view of an embodiment of the disclosure.

### DETAILED DESCRIPTION OF THE INVENTION

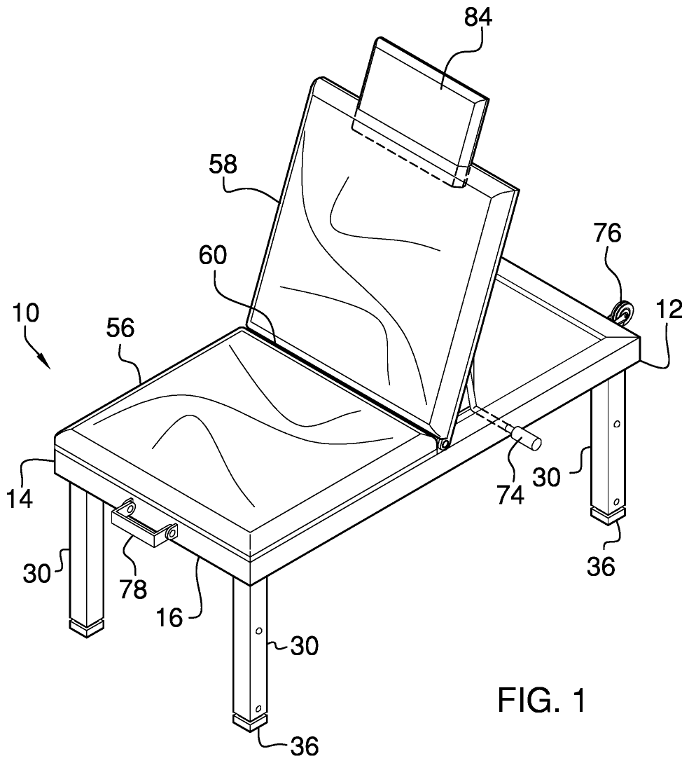

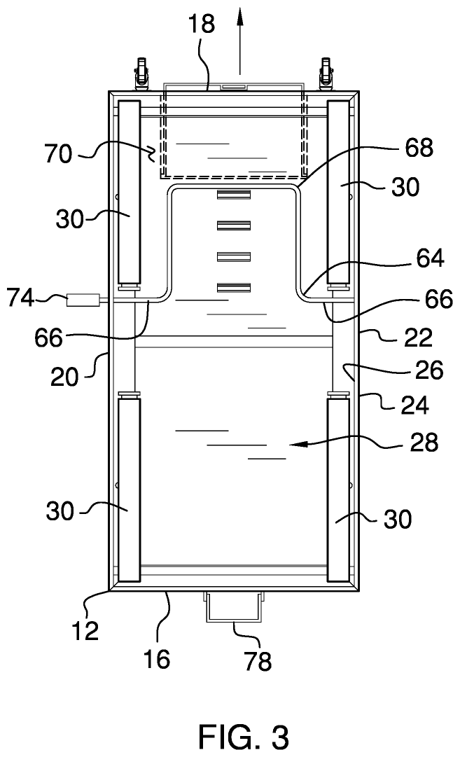

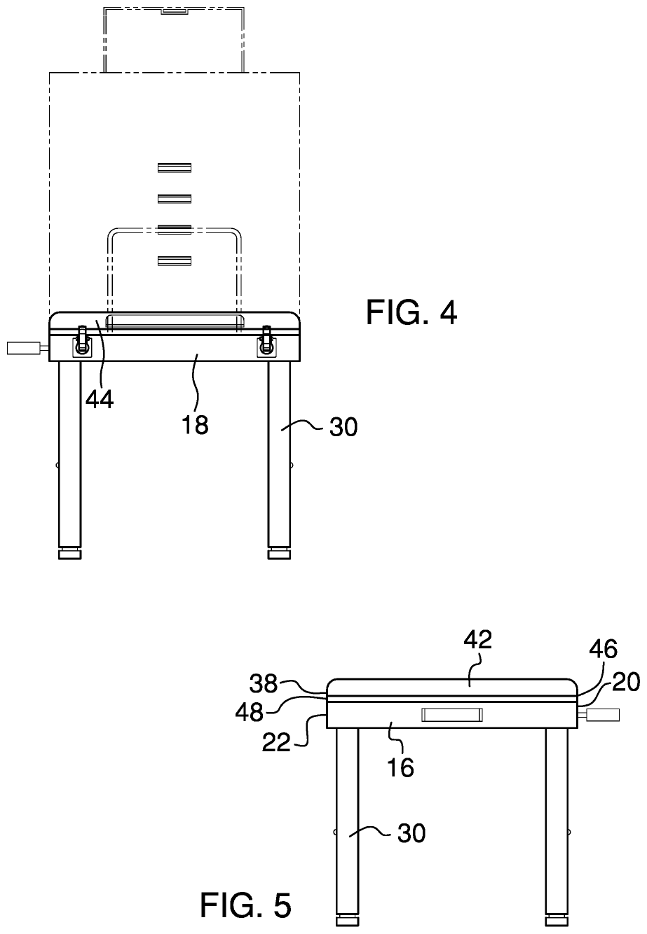

With reference now to the drawings, and in particular to FIGS. 1 through 6 thereof, a new welder seat device embodying the principles and concepts of an embodiment of the disclosure and generally designated by the reference numeral 10 will be described.

As best illustrated in FIGS. 1 through 6, the adjustable welder table assembly 10 generally comprises a frame 12 that has a perimeter edge 14 and includes a front member 16, a rear member 18, a first lateral member 20 and a second lateral member 22. The frame 12 has an interior surface 24 and an exterior surface 26 wherein the interior surface 24 bounds an interior space 28. The interior space 28 has a height that is no greater than 6.0 inches. Furthermore, the frame 12 has a length is between 2.0 feet and 4.0 feet and a width is between 1 foot and 2.0 feet. The frame 12 may be comprised of any conventional materials used for a support bench including metal, wood and plastics.

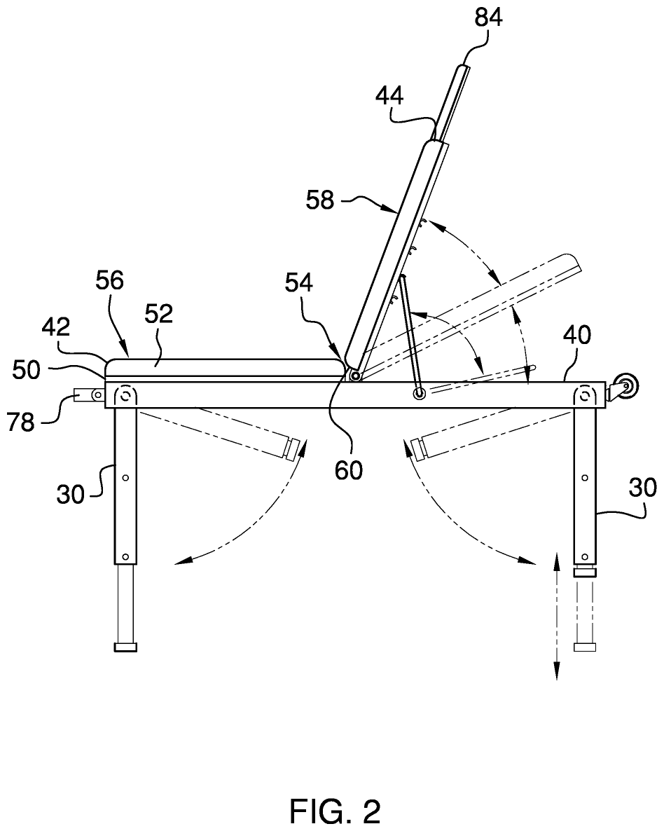

A plurality of legs 30 is attached to the frame 12. The legs 30 are pivotally coupled to the frame 12 and are positionable in an extended position extending downwardly from the frame 12 or in a stored position positioned within the interior 28 and bounded by the frame 12 such that a bottom edge 32 of the frame 12 is abuttable against a floor surface 34 to define a lowest support position of the assembly 10. As shown in FIG. 2, each of the legs 30 may be telescopic such that the legs 30 have an adjustable height. The legs 30 will each typically have a maximum height that is no greater than 3.0 feet. The legs 30 may each terminate with a friction enhanced foot 36.

A platform 38 is positioned on an upper surface 40 of the frame 12. The platform 38 has a front edge 42 positioned adjacent to the front member 16, a rear edge 44 positioned adjacent to the rear member 18, a first lateral edge 46, and a second lateral edge 48. The platform 38 has a base layer 50 that is comprised of a rigid material. Additionally, the platform 38 will most typically include a cushioning layer 52 that is positioned above the base layer 50 for abutment against a welder's body. In one embodiment, the legs 30 may have a shortest height such that the upper surface 40 is elevated approximately 18 inches and can be telescoped to a greatest height of approximately 24 inches.

The platform 38 has a break 54 therein extending between and through the first 46 and second 48 lateral edges. The break 54 is spaced from the front 42 and rear 44 edges to define a first section 56 and a second section 58, wherein the second section 58 includes the rear edge 44. The second section 58 includes an inner edge 60 that is positioned adjacent to the break 54. The second section 58 is pivotally coupled to the frame 12 adjacent to the inner edge 60 to allow the rear edge 44 to be vertically spaced from the rear member 18. In one embodiment, each of the first 56 and second 58 sections are substantially square shaped such that each has a length equal to about 15 inches and a width equal to about 15 inches.

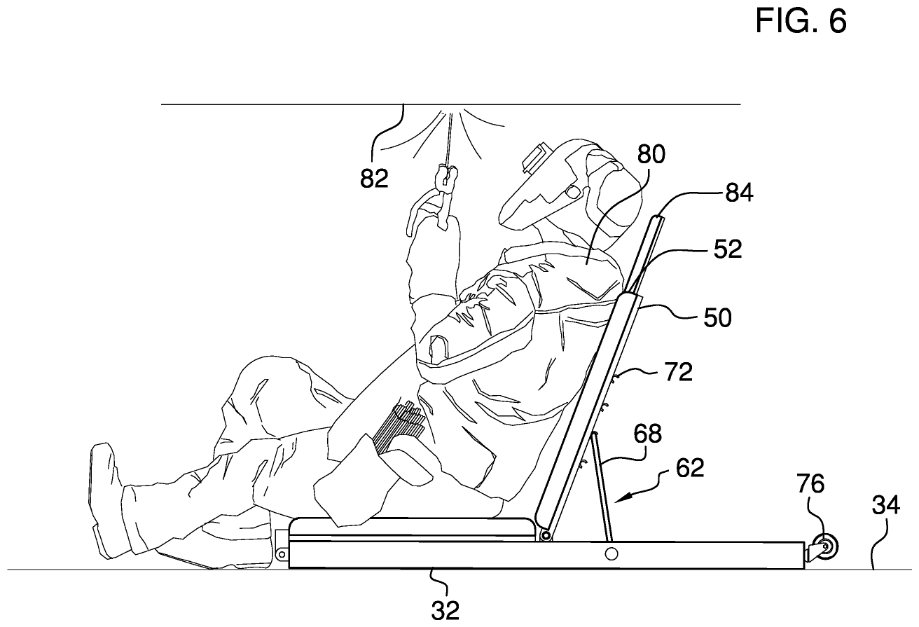

A brace 62 is attached to the frame 12. The brace 62 is engageable with the second section 58 so that the brace 62 retains the second section 58 at a selected angle relative to the frame 12. The brace 62 may include a rod 64 having a pair of linear portions 66 in linear alignment with each other and a U-shaped portion 68 positioned between the linear portions 66. Each of the linear portions 66 is rotatably coupled to the frame 12 between the rear member 18 and the break 54 such a central area of the U-shaped portion 68 is abuttable against a bottom surface 70 of the second section 58. The second section 58 may include a plurality of receivers 72, spaced from each other, wherein the brace 62 is releasably engageable with one of the receivers 72 as shown in FIG. 6. A grip 74 is attached to one of the linear portions 66 to rotate the U-shaped portion relative to the frame 12 and second section 58.

A plurality of wheels 76 is rotatably coupled to the exterior surface 24. The wheels 74 are most typically positioned on the rear member 18. A handle 78 is attached to the exterior surface 24 of the frame 12 to facilitate transportation of the frame 12 and is positioned on the front member 16. The frame 12 may be picked up with the handle 78 such that the wheels 76 engage the floor surface 34. The assembly 10 may include conventional fastening devices for retaining the second section 58 in a flat position and the legs 30 in the stored condition during transportation of the assembly 10.

For additional comfort, one of the first 56 or second 58 sections may include a retractable headrest 84 that can be extended therefrom. Typically the second section 58 will include the headrest 84 in a pocket formed in the platform 38 and/or cushioning layer 52 and will be extendable outwardly away from the rear edge 44. The headrest will have a width of between 8 inches and 12 inches can extend away from the rear edge 44 between 6 inches and 12 inches.

In use, the assembly 10 functions as a bench or a chair for a person performing welding tasks. When the legs 30 are placed within the interior 28, the total height of the assembly 10 is restricted only to the height of the frame 12 and the platform 38 and thus will be less than 8.0 inches and more typically less than 4.0 inches. This will allow a welder 80 to lie in a supine position such that the welder 80 can work above their body and under the object, i.e. workpiece 82, being worked upon. However, the legs 30 may be extended as needed to lift the platform 38 upwardly depending on the height of the workpiece 82. Additionally, the second section 34 may be angled from 15° to 75°, relative to a horizontal orientation of the frame 12 and first section 56, to allow a person to be seated more upright as shown in FIG. 6, again depending on the height and positioning of workpiece. The wheels 76 and handle 78 allow the assembly 10 to be moved as needed relative to the workpiece 82. Additionally, tools may be placed on the assembly 10 and more easily transported as well using the handle 78 and wheels 76.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A chair assembly for supporting a welder at various heights relative to a floor surface, said assembly comprising:
a frame having a perimeter edge and including a front member, a rear member, a first lateral member and a second lateral member, said frame having an interior surface and an exterior surface, said interior surface bounding an interior space;
a plurality of legs being attached to said frame, said legs being pivotally coupled to said frame and being positionable in an extended position extending downwardly from said frame or in a stored position positioned within said interior and bounded by said frame such that a bottom edge of said frame is abuttable against a floor surface to define a lowest support position of said assembly; and
a platform being positioned on an upper surface of said frame for supporting the welder while performing a welding task.

2. The chair assembly according to claim 1, wherein said interior space has a height being no greater than 6.0 inches.

3. The chair assembly according to claim 2, wherein said frame has a length being between 2.0 feet and 4.0 feet and a width being between 1 foot and 2.0 feet.

4. The chair assembly according to claim 4, wherein each of said legs is telescopic, said legs each having a maximum height being no greater than 3.0 feet.

5. The chair assembly according to claim 4, wherein said platform has a front edge positioned adjacent to said front member, a rear edge positioned adjacent to said rear member, a first lateral edge and a second lateral edge, said platform having a base layer being comprised of a rigid material.

6. The chair assembly according to claim 5, wherein said platform includes a cushioning layer being positioned above said base layer.

7. The chair assembly according to claim 5, wherein said platform has a break therein extending between and through said first and second lateral edges, said break being spaced from said front and rear edges to define a first section and a second section, said second section including said rear edge, said second section including an inner edge being positioned adjacent to said break, said second section being pivotally coupled to said frame adjacent to said inner edge to allow said rear edge to vertically spaced from said rear member, a brace being attached to said frame, said brace being engageable with said second section, said brace retaining said second section at a selected angle relative to said frame.

8. The chair assembly according to claim 5, further including a plurality of wheels being rotatably coupled to said exterior surface.

9. The chair assembly according to claim 8, wherein said wheels are positioned on said rear member.

10. The chair assembly according to claim 8, further including a handle being attached to said exterior surface of said frame to facilitate transportation of said frame.

11. The chair assembly according to claim 9, further including a handle being attached to said exterior surface of said frame to facilitate transportation of said frame, said handle being positioned on said front member.

12. A chair assembly for supporting a welder at various heights relative to a floor surface, said assembly comprising:
a frame having a perimeter edge and including a front member, a rear member, a first lateral member and a second lateral member, said frame having an interior surface and an exterior surface, said interior surface bounding an interior space, said interior space having a height being no greater than 6.0 inches, said frame having a length being between 2.0 feet and 4.0 feet and a width being between 1 foot and 2.0 feet;
a plurality of legs being attached to said frame, said legs being pivotally coupled to said frame and being positionable in an extended position extending downwardly from said frame or in a stored position positioned within said interior and bounded by said frame such that a bottom edge of said frame is abuttable against a floor surface to define a lowest support position of said assembly, each of said legs being telescopic, said legs having a maximum height being no greater than 3.0 feet;
a platform being positioned on an upper surface of said frame, said platform having a front edge positioned adjacent to said front member, a rear edge positioned adjacent to said rear member, a first lateral edge and a second lateral edge, said platform having a base layer being comprised of a rigid material, said platform including a cushioning layer being positioned above said base layer;
said platform having a break therein extending between and through said first and second lateral edges, said break being spaced from said front and rear edges to define a first section and a second section, said second section including said rear edge, said second section including an inner edge being positioned adjacent to said break, said second section being pivotally coupled to said frame adjacent to said inner edge to allow said rear edge to vertically spaced from said rear member;
a brace being attached to said frame, said brace being engageable with said second section and said brace retaining said second section at a selected angle relative to said frame;
a plurality of wheels being rotatably coupled to said exterior surface, said wheels being positioned on said rear member; and
a handle being attached to said exterior surface of said frame to facilitate transportation of said frame, said handle being positioned on said front member.
